(19) United States
(12) Patent Application Publication
(10) Pub. No.: US 2025/0338212 A1
(43) Pub. Date: Oct. 30, 2025

(54) ELECTRONIC TAG SYSTEMS DOWNLINK (DL) WAKEUP DATA

(71) Applicant: QUALCOMM Incorporated, San Diego, CA (US)

(72) Inventors: Zhifei FAN, San Diego, CA (US); Chengjin ZHANG, San Diego, CA (US); Ahmed Abdelaziz Ibrahim Abdelaziz ZEWAIL, San Diego, CA (US)

(21) Appl. No.: 18/646,568

(22) Filed: Apr. 25, 2024

(51) Int. Cl. H04W 52/02; H04W 56/00

(52) U.S. Cl. CPC H04W 52/0229; H04W 56/001

(57) ABSTRACT

Disclosed are systems and techniques for wireless communications. For example, a computing device can receive an energizing signal from a second device, the energizing signal comprising a wakeup signal including a preamble portion and a data portion, wherein the preamble portion indicates timing of the data portion and the data portion indicates one or more channels for transmission by the first device. The computing device can receive energy from the energizing signal. The computing device can transmit, to the second device based on an amount of the energy received, a response signal using one channel of the one or more channels for transmission.

### FIELD

The present disclosure generally relates to wireless communications. For example, aspects of the present disclosure relate to electronic tag systems downlink (DL) wakeup data.

### BACKGROUND

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for electronic tag systems downlink (DL) wakeup data. According to at least one example, a first device for wireless communications is provided. The first device include at least one memory and at least one processor coupled to the at least one memory and configured to: receive an energizing signal from a second device, the energizing signal comprising a wakeup signal including a preamble portion and a data portion, wherein the preamble portion indicates timing of the data portion and the data portion indicates one or more channels for transmission by the first device; receive energy from the energizing signal; and output, for transmission to the second device based on an amount of the energy received, a response signal using one channel of the one or more channels for transmission.

In another illustrative example, a method is provided for wireless communications. The method includes: receiving, by a first device, an energizing signal from a second device, the energizing signal comprising a wakeup signal including a preamble portion and a data portion, wherein the preamble portion indicates timing of the data portion and the data portion indicates one or more channels for transmission by the first device; receiving, by the first device, energy from the energizing signal; and transmitting, by the first device to the second device based on an amount of the energy received, a response signal using one channel of the one or more channels for transmission.

In another illustrative example, a non-transitory computer-readable medium is provided having stored thereon instructions that, when executed by at least one processor, cause the at least one processor to: receive an energizing signal from a second device, the energizing signal comprising a wakeup signal including a preamble portion and a data portion, wherein the preamble portion indicates timing of the data portion and the data portion indicates one or more channels for transmission by the first device; receive energy from the energizing signal; and output, for transmission to the second device based on an amount of the energy received, a response signal using one channel of the one or more channels for transmission.

In another illustrative example, an apparatus is provided for wireless communications. The apparatus includes: means for receiving an energizing signal from a second device, the energizing signal comprising a wakeup signal including a preamble portion and a data portion, wherein the preamble portion indicates timing of the data portion and the data portion indicates one or more channels for transmission by the first device; means for receiving energy from the energizing signal; and means for transmitting, to the second device based on an amount of the energy received, a response signal using one channel of the one or more channels for transmission.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example of a wireless communication network, in accordance with some aspects.

FIG. 2 is a diagram illustrating a design of a base station and a user equipment (UE) device that enable transmission and processing of signals exchanged between the UE and the base station, in accordance with some aspects.

FIG. 3 is a diagram illustrating an example of a disaggregated base station, in accordance with some aspects.

FIG. 4 is a block diagram illustrating example components of a UE, in accordance with some aspects.

FIG. 5 is a block diagram illustrating example components of radio frequency (RF) energy harvesting device, such as in the form of a passive radio frequency identification (RFID) tag, in accordance with some aspects.

FIG. 6 is a diagram illustrating an example of a system including a passive RFID tag, in accordance with some aspects.

FIG. 7 is a block diagram illustrating example components of an energy harvesting (EH) blue tooth low energy (BLE) tag, in accordance with some aspects.

FIG. 8 is a diagram illustrating an example of a system including an EH-BLE tag, in accordance with some aspects.

FIG. 9 is a diagram illustrating example components of a wakeup signal, in accordance with some aspects.

FIG. 10 is a diagram illustrating examples of downlink signals, in accordance with some aspects.

FIG. 11 is a flow diagram illustrating an example of a process for frequency synchronization, in accordance with some aspects.

FIG. 12 is a flow diagram illustrating another example of a process for wireless communication, in accordance with some aspects.

FIG. 13 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In various wireless communication networks, various client devices can be utilized that may be associated with different signaling and communication needs. For example, as 5G networks expand into industrial verticals and the quantity of deployed Internet-of-Things (IoT) devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, etc.

Currently, electronic tags (etags) are a rapidly growing technology impacting many industries, due to their economic potential for inventory and/or asset management inside and outside warehouses, IoT devices, sustainable sensor networks in factories and/or agriculture, and smart home usage. Electronic tags consist of small transponders, or tags, that emit an information-bearing signal after receiving a signal. Electronic tags can operate without a battery at a low operating expense (OPEX), with a low maintenance cost, and with a long-life cycle. Electronic tags can harvest energy over-the-air and power their transmission and reception circuitry.

For example, passive IoT devices and semi-passive IoT devices (e.g., which may be in the form of electronic tags) are relatively low-cost UEs that may be used to implement one or more sensing and communication capabilities in an ambient IoT network (or system, such as an electronic shelf label (ESL) system) or deployment. In some examples, passive IoT devices and semi-passive IoT devices can be used to provide sensing capabilities for various processes and use cases, such as asset management, logistics, warehousing, manufacturing, etc. Passive IoT devices and semi-passive IoT devices can include one or more sensors, a processor or micro-controller, and an energy harvester for generating electrical power from incident downlink (DL) radio frequency (RF) signals received at the IoT device. In one or more examples, passive IoT devices can passively backscatter received signals (e.g., by modulating information onto the received signals), and semi-passive IoT devices can include a small energy storage element (e.g., a capacitor) to store energy and, as such, can actively transmit signals by using the stored energy.

Based on harvesting energy from incident downlink RF signals (e.g., transmitted by a network device, such as a tag reader or interrogator), energy harvesting devices (e.g., such as semi-passive IoT devices, which may be in the form of electronic tags) can be provided with a relatively small energy storage element, such as in the form of a capacitor. Energy harvesting devices can be deployed at large scales, based on the simplification in their manufacture and deployment associated with implementing wireless energy harvesting.

In a wireless communication environment (e.g., BLE environment), a device (e.g., such as a tag reader or interrogator) can be used to transmit downlink RF signals to energy harvesting devices. In one illustrative example, a tag reader can read and/or write information stored on energy harvesting IoT devices (e.g., electronic tags) by transmitting the downlink RF signal. The downlink RF signal can provide energy to an energy harvesting IoT device. The energy harvesting IoT device can transmit a response signal (e.g., an information-bearing uplink signal) back to the tag reader, after the energy harvesting IoT device is sufficiently energized. The tag reader can read the signal transmitted by an energy harvesting IoT device to decode the information transmitted by the IoT device (e.g., such as sensor information collected by one or more sensors included in the IoT device, etc.).

An energy harvesting tag (EH-tag) system is an ambient IoT system. The system generally includes an energizer (e.g., a tag reader or interrogator, which may be in the form of a base station, such as a gNB) and an electronic tag (e.g., which is a low cost device). An electronic tag does not include a battery and relies on wireless power transfer (WPT) from over-the-air to perform energy harvesting (e.g., to harvest energy from the wireless signals transmitted from the energizer). The energizer can send a downlink wireless power transfer waveform (e.g., including a continuous waveform) to the electronic tags.

The electronic tag also does not include a clock crystal (XTAL). If the electronic tag is a semi-passive IoT device (e.g., including a small energy storage element to store energy and can actively transmit signals by using the stored energy), the electronic tag will need to rely on over-the-air-signals for frequency tuning (e.g., for tuning the frequency for transmissions). As such, improved systems and techniques that provide a downlink (DL) signal for electronic tag systems that include data for channel selection and frequency synchronization for transmissions can be beneficial.

In one or more aspects, systems, apparatuses, processes (also referred to as methods), and computer-readable media (collectively referred to herein as “systems and techniques”) are described herein for providing electronic tag systems downlink (DL) wakeup data. In one or more examples, the systems and techniques provide an energizing signal (e.g., a downlink signal transmitted by a reader or interrogator device) for an electronic tag (e.g., which may be in the form of a passive IoT device, such as a backscatter device, or a semi-passive IoT device) that includes a wakeup signal (WUS) and a synchronization signal (SYNC). In one or more examples, the wakeup signal is transmitted prior to the synchronization signal (e.g., including a synchronization waveform). In one or more examples, the wakeup signal includes a preamble portion (e.g., a wakeup signal preamble (WUS-P)) and a data portion (e.g., wakeup signal data (e.g., WUS-D)). In some examples, the data portion can indicate an electronic tag transmit channel selection, such as an indication of a fixed channel or multiple channels to use for transmissions.

In one or more examples, the synchronization signal can include a synchronization waveform (e.g., a clock synchronization waveform) that an electronic tag can use to tune its frequency, since the electronic tag does not include a clock crystal. In some examples, the wakeup signal can be used by an electronic tag for time synchronization and can be used to trigger the electronic tag to perform a clock synchronization (e.g., tune its frequency to the synchronization waveform of the synchronization signal).

In one or more aspects, during operation of the systems and techniques for wireless communications, a first device (e.g., an electronic tag) can receive an energizing signal from a second device (e.g., a tag reader or interrogator). In one or more examples, the energizing signal can include a wakeup signal (WUS). In some examples, the wakeup signal can include a preamble portion (WUS-P) and a data portion (WUS-D). In one or more examples, the preamble portion can indicate timing of the data portion. In some examples, the data portion can indicate one or more channels for transmission by the first device. The first device can receive energy from the energizing signal. The first device can transmit, to the second device based on an amount of the energy received, a response signal using one channel of the one or more channels for transmission.

In one or more examples, the energizing signal can further include a synchronization signal (SYNC) including a synchronization waveform. In some examples, the receiving, by the first device of the energizing signal can include receiving the wakeup signal at a first time, and receiving the synchronization signal at a second time. In one or more examples, the receiving of the synchronization signal at the second time can be based on a time delay between transmission of the wakeup signal and the synchronization signal.

In some examples, the first device can search for a sequence of the wakeup signal. In one or more examples, the first device, in response to detection of the sequence of the wakeup signal, can tune a frequency for the first device based on the synchronization waveform of the synchronization signal.

In one or more examples, the data portion can include channel selection information indicating the one or more channels for transmission by the first device. In some examples, the channel selection information can include a first bit (e.g., a zero bit) corresponding to a fixed channel or a second bit (e.g., a one bit) corresponding to multiple channels.

In some examples, the wakeup signal can include amplitude shift keying (ASK), phase shift keying (PSK), frequency shift keying (FSK), orthogonal frequency-division multiplexing (OFDM), or discrete Fourier transform-spread-orthogonal frequency-division multiplexing (DFT-S-OFDM). In one or more examples, when the wakeup signal includes amplitude shift keying, an on stage (e.g., a one bit) of the wakeup signal can be indicated by a first power (e.g., a high power) using on-off keying, a sinewave, a constant envelope, orthogonal frequency-division multiplexing, or discrete Fourier transform-spread-orthogonal frequency-division multiplexing. In some examples, an off stage (e.g., a zero bit) of the wakeup signal can be indicated by no power within the wakeup signal or a second power (e.g., a low power) within the wakeup signal, where the first power is greater than the second power.

In one or more examples, the first device can store the energy from the energizing signal. In some examples, the first device can be an electronic tag. In one or more examples, the second device can be a tag reader.

Additional aspects of the present disclosure are described in more detail below.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

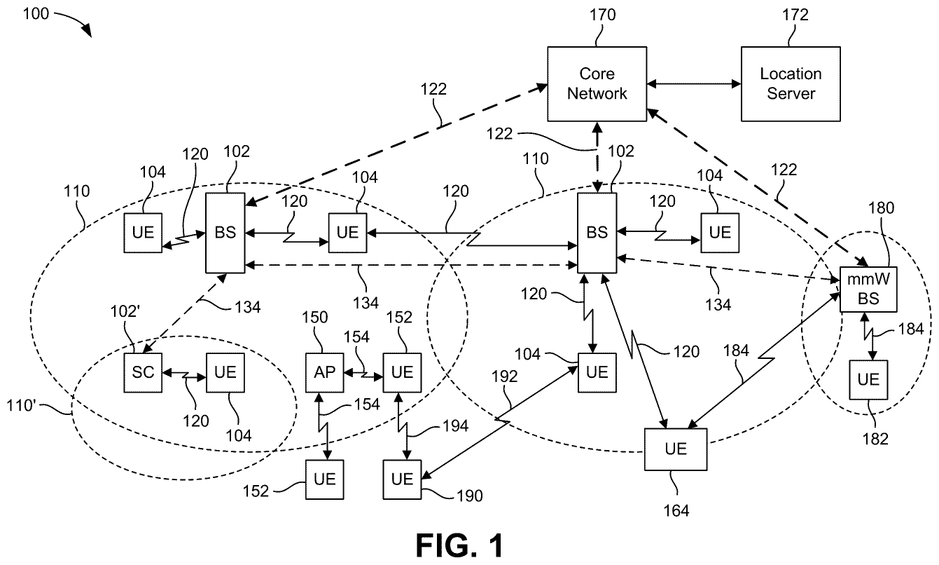

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

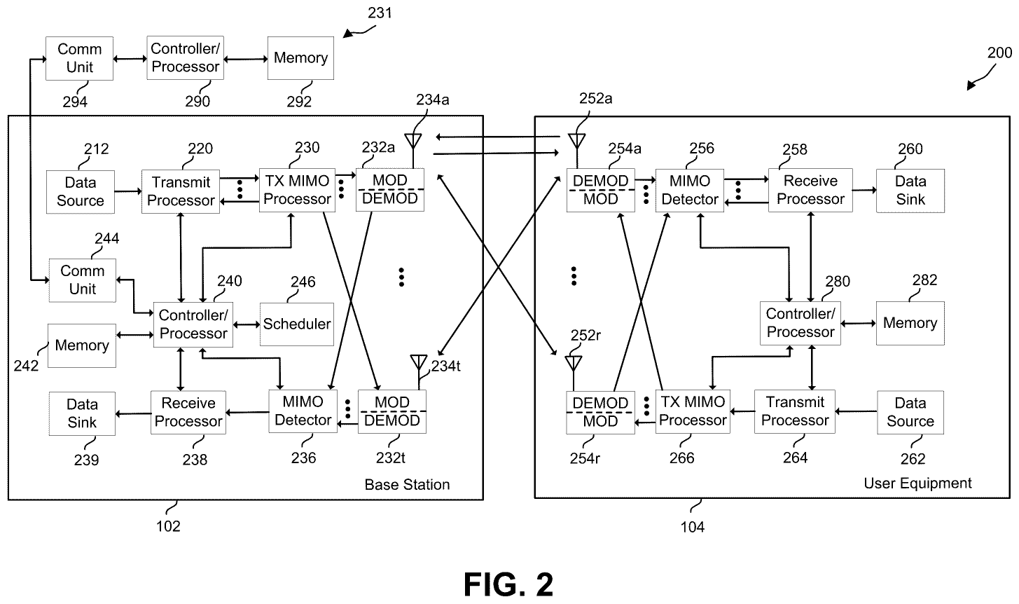

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

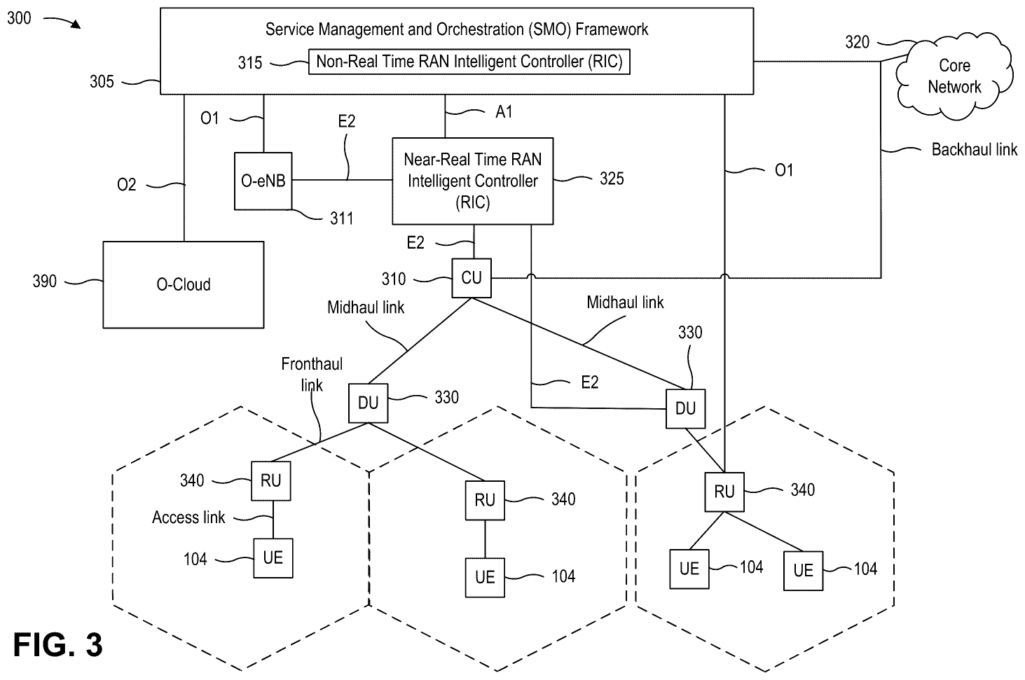

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

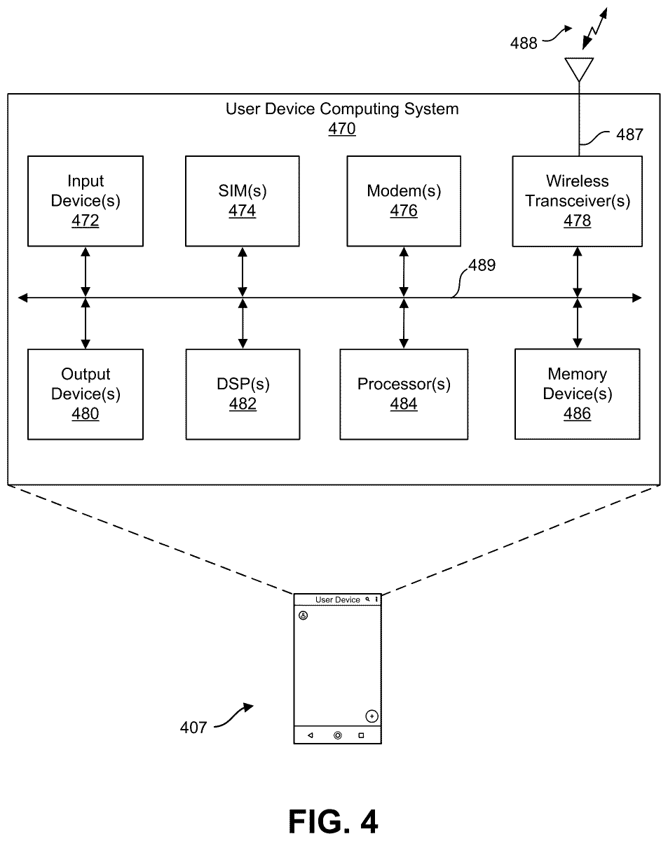

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

As previously mentioned, currently, electronic tags (etags) are a rapidly growing technology impacting many industries, due to their economic potential for inventory and/or asset management inside and outside warehouses, IoT devices, sustainable sensor networks in factories and/or agriculture, and smart home usage. Electronic tags can be implemented by small transponders, or tags, that emit an information-bearing signal after receiving a signal. Electronic tags may operate without a battery at a low OPEX, with a low maintenance cost, and with a long-life cycle. Electronic tags may harvest energy over-the-air and power their transmission and reception circuitry.

In one or more examples, passive IoT devices and semi-passive IoT devices (e.g., electronic tags) are relatively low-cost UEs that can be used to implement one or more sensing and communication capabilities in an ambient IoT network or system (e.g., an ESL system) or deployment. In one or more examples, passive IoT devices and semi-passive IoT devices may be used to provide sensing capabilities for various processes and use cases (e.g., asset management, logistics, warehousing, manufacturing, etc.). Passive IoT devices and semi-passive IoT devices may include one or more sensors, a processor or micro-controller, and an energy harvester for generating electrical power from incident DL RF signals received at the IoT device. In one or more examples, passive IoT devices may passively backscatter received signals (e.g., by modulating information onto the received signals), and semi-passive IoT devices may include a small energy store element (e.g., a capacitor) to store energy and, as such, can be able to actively transmit signals by using the stored energy.

Based on harvesting energy from incident downlink RF signals (e.g., transmitted by a device, for example a tag reader or interrogator), energy harvesting devices (e.g., semi-passive IoT devices, for example in the form of electronic tags) may be provided with a relatively small energy storage element, which may be in the form of a capacitor. Energy harvesting devices may be deployed at large scales, based on the simplification in their manufacture and deployment associated with implementing wireless energy harvesting.

In a wireless communication environment (e.g., a BLE environment), a device (e.g., a tag reader or interrogator) may be used to transmit downlink RF signals to energy harvesting devices. In one example, a tag reader may read and/or write information stored on energy harvesting IoT devices (e.g., electronic tags) by transmitting the downlink RF signal. The downlink RF signal may provide energy to an energy harvesting IoT device. The energy harvesting IoT device may transmit a response signal (e.g., an information-bearing uplink signal) back to the tag reader, after the energy harvesting IoT device is sufficiently energized. The tag reader may read the signal transmitted by an energy harvesting IoT device to decode the information transmitted by the IoT device (e.g., sensor information obtained by one or more sensors included in the IoT device, etc.).

An energy harvesting tag (EH-tag) system is an ambient IoT system. The system generally includes an energizer (e.g., a tag reader or interrogator, which can be in the form of a base station, such as a gNB) and an electronic tag (e.g., which is a low cost device). An electronic tag does not include a battery and relies on wireless power transfer (WPT) from over-the-air to perform energy harvesting (e.g., to harvest energy from the wireless signals transmitted from the energizer). The energizer may send a downlink wireless power transfer waveform (e.g., including a continuous waveform) to the electronic tags.

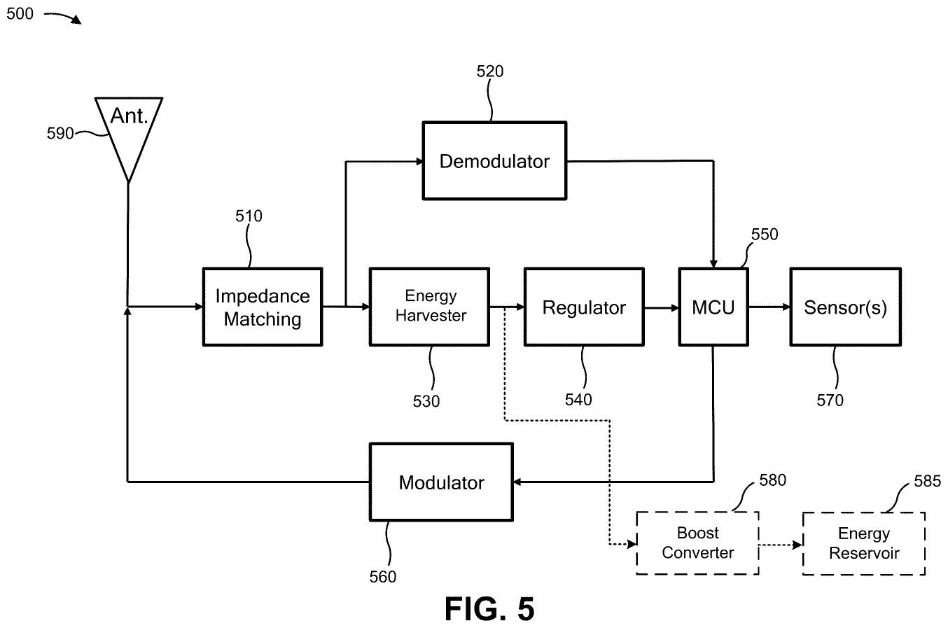

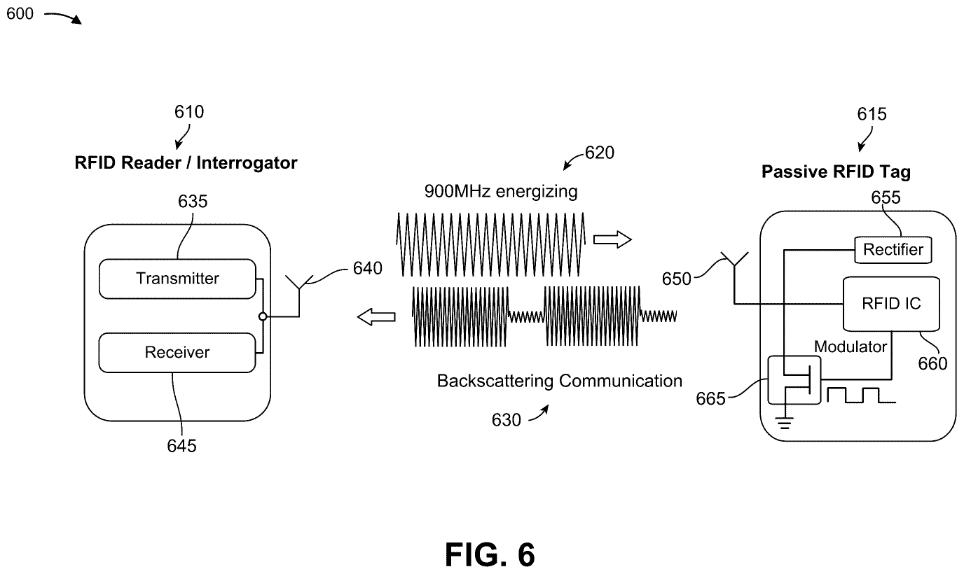

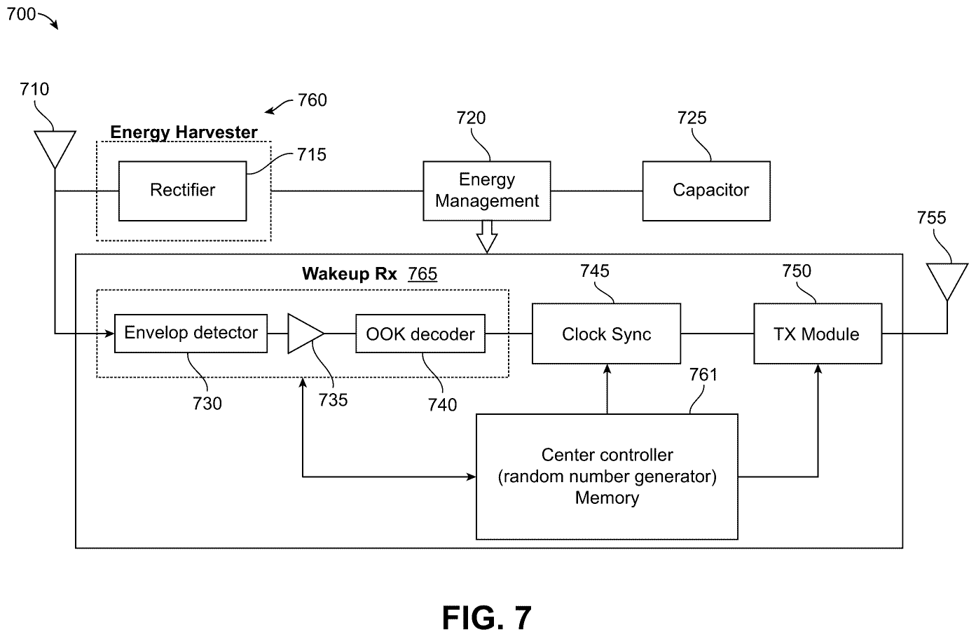

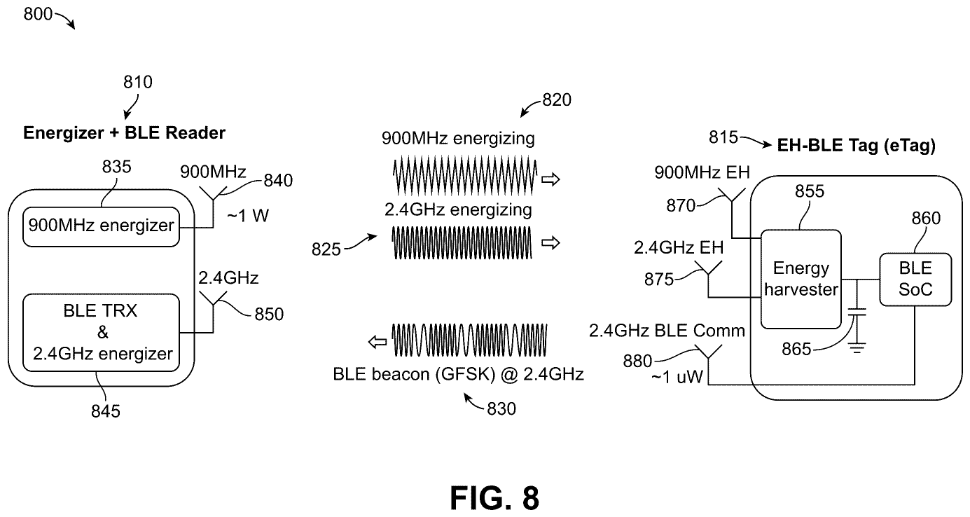

In a wireless environment, energy harvesting devices (e.g., in the form of electronic tags) can harvest energy from RF signals transmitted from a device (e.g., an energizer, such as a tag reader). FIGS. 5 and 7 show examples of low cost, energy harvesting devices that do not include batteries or clock crystals. In particular, FIG. 5 shows an example of a energy harvesting device that can passively backscatter signals, and FIG. 8 shows an example of an energy harvesting device that includes a capacitor to store energy and, as such, can perform an active transmission of a signal by using the stored energy. FIGS. 6 and 8 show examples of systems including the energy harvesting devices of FIGS. 5 and 7, respectively.

FIG. 5 is a diagram illustrating an example of an architecture of a radio frequency (RF) energy harvesting device 500, which may be in the form of a radio frequency identification (RFID) tag. As will be described in greater depth below, the RF energy harvesting device 500 can harvest RF energy from one or more RF signals received using an antenna 590. As used herein, the term “energy harvesting” may be used interchangeably with “power harvesting.” In some aspects, an “energy harvesting device” can be a device that is capable of performing energy harvesting (EH). For example, as used herein, the term “energy harvesting device” may be used interchangeably with the term “EH-capable device” or “energy harvesting-capable device.” In some aspects, energy harvesting device 500 can be implemented as an Internet-of-Things (IoT) device, can be implemented as a sensor, etc., as will be described in greater depth below. In other examples, energy harvesting device 500 can be implemented as a Radio-Frequency Identification (RFID) tag or various other RFID devices.

The energy harvesting device 500 includes one or more antennas 590 that can be used to transmit and receive one or more wireless signals. For example, energy harvesting device 500 can use antenna 590 to receive one or more downlink signals and to transmit one or more uplink signals. An impedance matching component 510 can be used to match the impedance of antenna 590 to the impedance of one or more (or all) of the receive components included in energy harvesting device 500. In some examples, the receive components of energy harvesting device 500 can include a demodulator 520 (e.g., for demodulating a received downlink signal), an energy harvester 530 (e.g., for harvesting RF energy from the received downlink signal), a regulator 540, a micro-controller unit (MCU) 550, a modulator 560 (e.g., for generating an uplink signal). In some cases, the receive components of energy harvesting device 500 may further include one or more sensors 570.

The downlink signals can be received from one or more transmitters. For example, energy harvesting device 500 may receive a downlink signal from a network node or network entity that is included in a same wireless network as the energy harvesting device 500. In some cases, the network entity can be a base station, gNB, etc., that communicates with the energy harvesting device 500 using a cellular communication network. For example, the cellular communication network can be implemented according to the 3G, 4G, 5G, and/or other cellular standard (e.g., including future standards such as 6G and beyond).

In some cases, energy harvesting device 500 can be implemented as a passive or semi-passive energy harvesting device (also referred to as a passive or semi-passive device), which perform passive uplink communication by modulating and reflecting a downlink signal received via antenna 590. A passive or semi-passive energy harvesting device may also be referred to as a passive or semi-passive EH-capable device, respectively. For example, passive and semi-passive energy harvesting devices may be unable to generate and transmit an uplink signal without first receiving a downlink signal that can be modulated and reflected.

A semi-passive energy harvesting device (e.g., also referred to as a semi-passive EH-capable device) may include one or more energy storage elements 585 (e.g., collectively referred to as an “energy reservoir”). For example, the one or more energy storage elements 585 can include capacitors, etc. In some examples, the one or more energy storage elements 585 may be associated with a boost converter 580. The boost converter 580 can receive as input at least a portion of the energy harvested by energy harvester 530 (e.g., with a remaining portion of the harvested energy being provided as instantaneous power for operating the energy harvesting device 500). In some aspects, the boost converter 580 may be a step-up converter that steps up voltage from its input to its output (e.g., and steps down current from its input to its output). In some examples, boost converter 580 can be used to step up the harvested energy generated by energy harvester 530 to a voltage level associated with charging the one or more energy storage elements 585. A semi-passive energy harvesting device may include one or more energy storage elements 585 and may include one or more boost converters 580. A quantity of energy storage elements 585 may be the same as or different than a quantity of boost converters 580 included in a semi-passive energy harvesting device.

A passive energy harvesting device (e.g., also referred to as a “passive EH-capable device” or “passive device”) does not include an energy storage element 585 or other on-device power source. For example, a passive energy harvesting device may be powered using only RF energy harvested from a downlink signal (e.g., using energy harvester 530). As mentioned previously, a semi-passive energy harvesting device can include one or more energy storage elements 585 and/or other on-device power sources. The energy storage element 585 of a semi-passive energy harvesting device can be used to augment or supplement the RF energy harvested from a downlink signal. In some cases, the energy storage element 585 of a semi-passive energy harvesting device may store insufficient energy to transmit an uplink communication without first receiving a downlink communication (e.g., minimum transmit power of the semi-passive device>capacity of the energy storage element). The energy storage element(s) 585 included in a semi-passive energy harvesting device can be charged using harvested RF energy.

FIG. 6 show an example of an RFID tag system. In particular, FIG. 6 is a diagram illustrating an example of a system 600 including a passive RFID tag, such as the RF energy harvesting device 500 of FIG. 5. In FIG. 6, the system 600 is shown to include a first device 615 (e.g., a passive RFID tag, in the form of an electronic tag) and a second device 610 (e.g., an RFID reader or interrogator device).

In FIG. 6, the first device 615 (e.g., an RFID tag, in the form of an electronic tag) is shown to include a rectifier 655 (e.g., for harvesting energy from received signals), an RFID integrated circuit (IC) 660, a transistor 665 (e.g., for modulating information onto a signal to be backscattered), and a transmit and receive antenna 650 (e.g., including a 900 megahertz receive antenna). The second device 610 (e.g., an RFID reader or interrogator device) is shown to include a transmitter 635 (e.g., a 900 megahertz energizer), a receiver 645, and a transmit and receive antenna 640 (e.g., including a 900 megahertz transmit antenna).

In one or more examples, during operation of the system 600, the transmitter 635 of the second device 610 (e.g., reader) can produce an energizing signal (e.g., 900 megahertz energizing signal). The transmit and receive antenna 640 can transmit the 900 megahertz energizing signal 620 to the first device 615 (e.g., an electronic tag). The transmit and receive antenna 650 of the first device 615 can receive the 900 megahertz energizing signal 620. The rectifier 655 of the first device 615 can then harvest energy from the 900 megahertz energizing signal 620.

After the first device 615 (e.g., tag) has received (e.g., harvested) a sufficient amount of energy for transmission, the transmit and receive antenna 650 of the first device 615 can transmit a backscattered signal 630 (e.g., a backscattered communication signal) to the second device 610 (e.g., reader). The transistor 665 of the first device 615 (e.g., tag) can modulate information (e.g., an identification associated with the first device 615 and/or sensor data obtained by one or more sensors of the first device 625) onto the received 900 megahertz energizing signal 620 and perform a frequency shift of the received 900 megahertz energizing signal 620 to produce the backscattered signal 630. The transmit and receive antenna 640 of the second device 615 (e.g., reader) can receive the backscattered signal 630. The receiver 645 of the second device 610 can then receive and process (e.g., decode) the backscattered signal 630.

FIG. 7 shows an example of an energy harvesting device (e.g., which may be in the form of an electronic tag) that can harvest energy from energizing devices. In particular, FIG. 7 is a block diagram illustrating example components of a device 700 in the form of an EH-BLE tag, such as an electronic tag (etag). In FIG. 7, the device 700 is shown to include a receive antenna 710, an energy harvester 760, an energy management module 720, a capacitor 725, a wakeup receive module 765, a clock synchronization module 745, a center controller 761, a transmit module 750, and a transmit antenna 755. In one or more examples, energy harvester can have a rectifier 715. In some examples, the wakeup receive module 765 can have an envelope detector 730, an power amplifier (PA) 735, and an on-off-keying (OOK) decoder 740. In one or more examples, the center controller 761 can include a random number generator and memory.

During operation of the device 700, the receive antenna 710 can receive a downlink signal transmitted from a tag reader (e.g., an energizer). The energy harvester 760 can harvest energy from the received downlink signal. The harvested energy can be stored within the capacitor 725.

In one or more examples, the wakeup receive module 765 can receive the downlink signal. The envelope detector 730 within the wakeup receive module 765 can detect an envelope of the downlink signal. After the envelope is detected, the envelop can be amplified by the power amplifier 735, within the wakeup receive module 765, to produce an amplified envelope. The OOK decoder 740 can decode the amplified envelope to produce a synchronization signal and a random number range (Q). The clock synchronization module 745 can use the synchronization signal to synchronize a voltage controlled oscillator (VCO) of the device 700 to tune the transmission frequency for the device. The center controller 761 can use the random number range Q to determine a random number (m). The energy management module 720 can determine whether the capacitor 725 has a sufficient amount of energy (e.g., voltage) stored such that the device 700 is capable of transmitting. The transmit module 750 can use the random number (m) in conjunction with the determination by the energy management module 720 that the capacitor 725 has a sufficient amount of energy stored such that the device 700 is capable of transmitting to determine when the device 700 should transmit an uplink signal. The transmit antenna 755 can transmit the uplink signal (e.g., response signal) to the tag reader (e.g., an energizer).

FIG. 8 shows an example of an EH-tag system. In particular, FIG. 8 is a diagram illustrating an example of a system 800 including an EH-BLE tag, such as the device 700 of FIG. 7. In FIG. 8, the system 800 is shown ton include a first device 815 (e.g., an EH-BLE tag, in the form of an etag) and a second device 810 (e.g., an energizer and BLE reader device).

In FIG. 8, the first device 815 (e.g., an EH-BLE tag, in the form of an etag) is shown to include an energy harvester module 855 (e.g., for harvesting energy from received signals), a BLE system on a chip (SoC) 860, a capacitor 865 (e.g., for storing harvested energy), a first receive antenna 870 (e.g., a 900 megahertz energy harvester receive antenna), a second receive antenna 875 (e.g., a 2.4 gigahertz energy harvester receive antenna), and a transmit antenna 880 (e.g., a 2.4 gigahertz BLE communication transmit antenna). The second device 810 (e.g., an energizer and BLE reader device) is shown to include an energizer 835 (e.g., a 900 megahertz energizer), a transmitter and receiver (TRX)/energizer 845 (e.g., a BLE TRX and 2.4 gigahertz energizer), a transmit antenna 840 (e.g., a 900 megahertz energizer antenna), and a transmit and receive antenna 850 (e.g., a 2.4 gigahertz transmit and receive communication antenna).

In one or more examples, during operation of the system 800, the energizer 835 of the second device 810 (e.g., reader) can produce an energizing signal (e.g., 900 megahertz energizing signal). The transmit antenna 840 can transmit the 900 megahertz energizing signal 820 to the first device 815 (e.g., electronic tag). The receive antenna 870 of the first device 815 can receive the 900 megahertz energizing signal 820. The energy harvester 855 of the first device 815 can then harvest energy from the 900 megahertz energizing signal 820. The energy harvested from the 900 megahertz energizing signal 820 can be stored on the capacitor 865 of the first device 815.

The transmitter and receiver (TRX)/energizer 845 (e.g., a BLE TRX and 2.4 gigahertz energizer) of the second device 810 (e.g., reader) can produce an energizing signal (e.g., 2.4 gigahertz energizing signal). The transmit and receive antenna 850 can transmit the 2.4 gigahertz energizing signal 825 to the first device 815 (e.g., electronic tag). The receive antenna 875 of the first device 815 can receive the 2.4 gigahertz energizing signal 825, and the energy harvester 855 of the first device 815 can then harvest energy from the 2.4 gigahertz energizing signal 825. The energy harvested from the 2.4 gigahertz energizing signal 825 may be stored on the capacitor 865 of the first device 815.

In one or more examples, depending upon a random number (m) generated by the BLE SoC 860 in conjunction with a determination by the BLE SoC 860 that the capacitor 865 has a sufficient amount of energy stored such that the first device 815 is capable of transmitting, the transmit antenna 880 (e.g., a 2.4 gigahertz BLE communication transmit antenna) can transmit a 2.4 gigahertz communication signal 830 (e.g., a BLE beacon at 2.4 gigahertz, which may have quadrature phase shift keying (QPSK)) to the second device 810 (e.g., reader). The transmit and receive antenna 850 (e.g., a 2.4 gigahertz transmit and receive communication antenna) of the second device 810 can then receive the 2.4 gigahertz communication signal 830.

As previously mentioned, an electronic tag (e.g., such as in the form of a passive IoT device or a semi-passive IoT device) does not include a clock crystal (XTAL). If the electronic tag is a semi-passive IoT device (e.g., including a small energy storage element to store energy and can actively transmit signals by using the stored energy), the electronic tag will need to rely on over-the-air-signals for frequency tuning (e.g., for tuning the frequency for transmissions). Therefore, improved systems and techniques that provide a downlink (DL) signal for electronic tag systems that include data for channel selection and frequency synchronization for transmissions can be useful.

In one or more aspects, the systems and techniques provide electronic tag systems downlink (DL) wakeup data. In one or more examples, the systems and techniques provide an energizing signal (e.g., a downlink signal transmitted by a reader or interrogator device) for an electronic tag (e.g., which may be in the form of a passive IoT device, such as a backscatter device, such as device 500 of FIG. 5, or a semi-passive IoT device, such as device 700 of FIG. 7) that can include a wakeup signal (WUS) and a synchronization signal (SYNC). In one or more examples, the wakeup signal can be transmitted prior to the synchronization waveform. In one or more examples, the wakeup signal can include a preamble portion (e.g., a wakeup signal preamble (WUS-P)) and a data portion (e.g., wakeup signal data (e.g., WUS-D)). In some examples, the data portion can indicate an electronic tag transmit channel selection, such as an indication of a fixed channel or multiple channels to use for transmission (e.g., for an uplink signal).

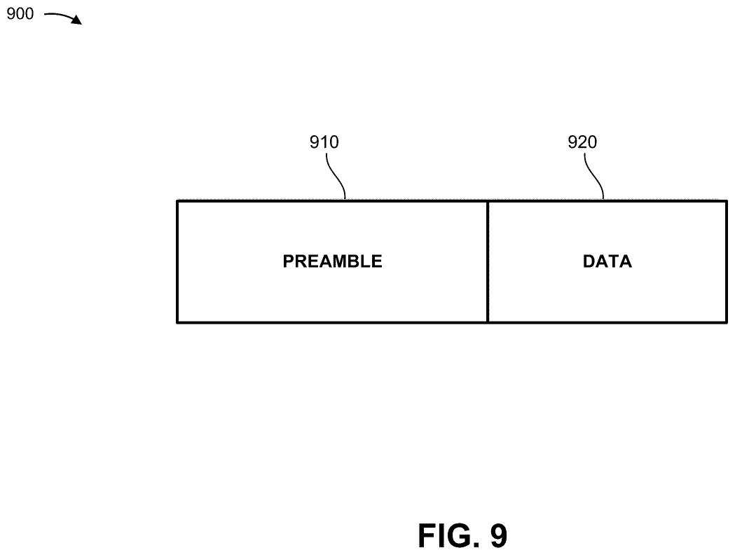

In one or more examples, the systems and techniques provide a structure for a wakeup signal of an energizer signal (e.g., a DL signal) transmitted by a device (e.g., a tag reader, which may be in the form of a base station, such as a gNB). FIG. 9 shows an example structure for a wakeup signal. In particular, FIG. 9 is a diagram illustrating example components of a wakeup signal (WUS) 900. In FIG. 9, the wakeup signal 900 is shown to include a preamble portion 910 (e.g., a wakeup signal preamble (WUS-P)) followed by a data portion 920 (e.g., wakeup signal data (WUS-D)). In one or more examples, the preamble portion 910 can indicate, to an electronic tag (e.g., which may be in the form of a passive IoT device, such as a backscatter device, such as device 500 of FIG. 5, or a semi-passive IoT device, such as device 700 of FIG. 7), timing of the data portion 920. For example, the preamble portion 910 can include a fixed sequence of bits. The electronic tag can already have this fixed sequence of bits stored within its memory. When the electronic tag detects this fixed sequence of bits of the preamble portion 910, the electronic tag can be aware that subsequent to receiving this sequence will be the data portion 920. As such, after the electronic tag receives the fixed sequence of bits of the preamble portion 910, the electronic tag can be aware that the next bit is associated with the data portion 920. The electronic tag can then decode the received bits within the data portion 920.

In some examples, the data portion 920 can convey some information to the electronic tags. In one or more examples, the data portion 920 can include information indicating electronic tag transmit channel selection (e.g., indicating one or more channels for transmission by the electronic tag in an uplink signal). In some examples, the channel selection can be indicated by an information bit (e.g., one broadcast information bit). In one or more examples, when the information bit is set to zero (0), the data portion 920 can indicate a fixed channel for the electronic tag to use for transmissions. In some examples, when the information bit is set to one (1), the data portion 920 can indicate multiple different channels for the electronic tag to choose from for transmissions. In one or more examples, the data portion 920 can include information indicating a random number range (Q) for a random number (m). In some examples, the data portion 920 can include information indicating correspondence of one or more time slots for transmissions with one or more respective frequency channels.

In one or more aspects of the systems and techniques, the synchronization signal of the energizer signal (e.g., a downlink signal transmitted by a reader or interrogator device) can include a synchronization waveform (e.g., a clock synchronization waveform, such as a continuous waveform (CW), for example a sinusoidal waveform, or a rectangular waveform) that an electronic tag (e.g., which may be in the form of a passive IoT device, such as a backscatter device, such as device 500 of FIG. 5, or a semi-passive IoT device, such as device 700 of FIG. 7) can use to tune its frequency, since the electronic tag does not include a clock crystal. In some examples, the wakeup signal can be used by an electronic tag for time synchronization and can be used to trigger the electronic tag to perform a clock synchronization (e.g., tune its frequency to the synchronization waveform of the synchronization signal).

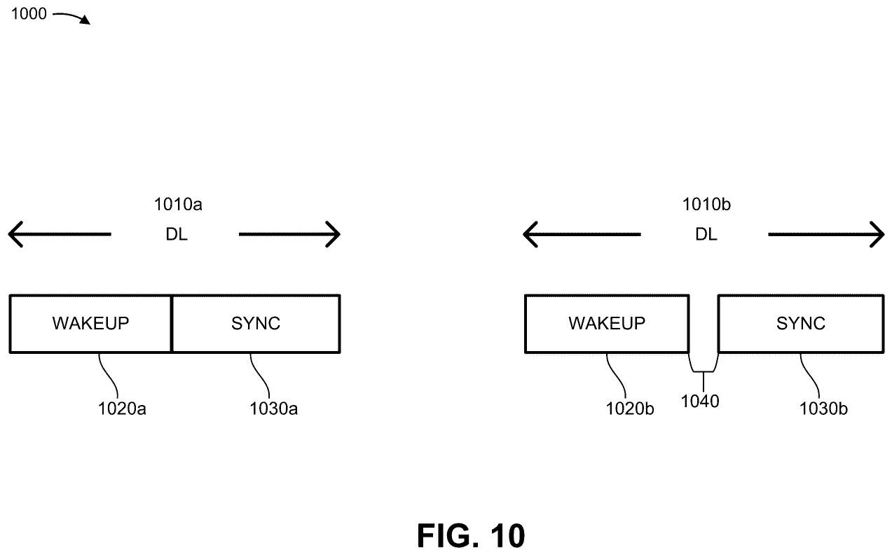

FIG. 10 shows an examples of downlink signals, each including a wakeup signal and a synchronization signal. In particular, FIG. 10 is a diagram illustrating examples 1000 of downlink signals 1010a, 1010b. In FIG. 10, the downlink signal 1010a is shown to include a wakeup signal 1020a and a synchronization signal 1030a, and the downlink signal 1010b is shown to include a wakeup signal 1020b and a synchronization signal 1030b. In one or more examples, a wakeup signal (e.g., wakeup signal 1020a, 1020b) of a downlink signal (e.g., downlink signal 1010a, 1010b) can be transmitted prior to the synchronization signal (e.g., synchronization signal 1030a, 1030b), as is shown in FIG. 10. The wakeup signal can be transmitted before the synchronization signal such that the wakeup signal can trigger the electronic tag to perform clock synchronization based on the synchronization signal.

In one or more examples, as shown in the downlink signal 1010a, the synchronization signal 1030a may be transmitted immediately after the transmission of the wakeup signal 1020a. In some examples, as shown in the downlink signal 1010b, the synchronization signal 1030b may be transmitted after a certain time delay 1040 after the transmission of the wakeup signal 1020b. In one or more examples, the time delay 1040 may allow for time for the electronic tag to perform frequency tuning.

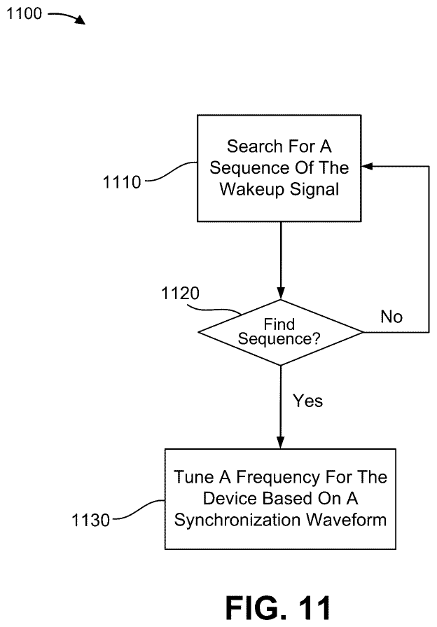

FIG. 11 shows an example process for an electronic tag to synchronize with an energizer. In particular, FIG. 11 is a flow diagram illustrating an example of a process for frequency synchronization by an electronic tag (e.g., which may be in the form of a passive IoT device, such as a backscatter device, such as device 500 of FIG. 5, or a semi-passive IoT device, such as device 700 of FIG. 7) with an energizer (e.g., a reader or interrogator device, which may be in the form of a base station, such as a gNB).

In one or more examples, during operation of the process 1100 of FIG. 11, at block 1110, an electronic tag can search for a sequence (e.g., a specific fixed sequence) of a wakeup signal (WUS) of an energizer signal (e.g., a downlink signal) transmitted by an energizer. At block 1120, the electronic tag can determine whether the electronic tag has detected the sequence (e.g., the specific fixed sequence) within a wakeup signal. In one or more examples, the electronic tag can perform autocorrelation with a received sequence from a wakeup signal to determine if there is a peak, thereby indicating that the received sequence corresponds to a fixed sequence for the wakeup signal that the electronic tag has already stored within its memory.

When the electronic tag determines that the sequence (e.g., the specific fixed sequence) for the wakeup signal has not been detected, the process 1100 can proceed back to block 1100 and the electronic tag can continue to search for the sequence. However, when the electronic tag determines that the sequence (e.g., the specific fixed sequence) for the wakeup signal has been detected, at block 1130, the electronic tag can tune a frequency for the electronic tag based on a synchronization waveform (e.g., a CW) of the synchronization signal within the energizer signal (e.g., a downlink signal transmitted by a reader or interrogator device). In one or more examples, the electronic tag can tune the frequency (e.g., transmission frequency) by tuning its local oscillator (e.g., a voltage controlled oscillator (VCO)) based on the synchronization waveform of the synchronization signal within the energizer signal.

In one or more aspects, during operation of the systems and techniques for wireless communications, a first device (e.g., which may be in the form of a passive IoT device, such as a backscatter device, such as device 500 of FIG. 5, or a semi-passive IoT device, such as device 700 of FIG. 7) may receive an energizing signal from a second device (e.g., a tag reader, which may be in the form of a base station, such as a gNB). In one or more examples, the energizing signal may include a wakeup signal (WUS). In some examples, the wakeup signal may include a preamble portion (WUS-P) and a data portion (WUS-D). In one or more examples, the preamble portion may indicate timing of the data portion. In some examples, the data portion may indicate one or more channels for transmission by the first device. The first device may receive energy from the energizing signal. The first device may transmit, to the second device based on an amount of the energy received, a response signal using one channel of the one or more channels for transmission.

In one or more examples, the energizing signal may further include a synchronization signal (SYNC) comprising a synchronization waveform (e.g., CW). In some examples, the receiving, by the first device of the energizing signal may include receiving the wakeup signal at a first time, and receiving the synchronization signal at a second time. In one or more examples, the receiving of the synchronization signal at the second time may be based on a time delay between transmission of the wakeup signal and the synchronization signal.

In some examples, the first device may search for a sequence of the wakeup signal. In one or more examples, the first device, in response to detection of the sequence of the wakeup signal, may tune a frequency (e.g., a transmission frequency for the response signal, which may be an uplink signal) for the first device based on the synchronization waveform of the synchronization signal.

In one or more examples, the data portion may include channel selection information indicating the one or more channels for transmission by the first device. In some examples, the channel selection information may include a first bit (e.g., a zero (0) bit) corresponding to a fixed channel or a second bit (e.g., a one (1) bit) corresponding to multiple channels. The first device (e.g., the tag) can perform channel selection based on the channel selection information. For instance, the first device can select a single channel if the bit is the first bit (e.g., a zero (0) bit) or can select one of the multiple channels (or more than one of the multiple channels) if the bit is the second bit (e.g., a one (1) bit).

In some examples, the wakeup signal may include amplitude shift keying (ASK), phase shift keying (PSK), frequency shift keying (FSK), orthogonal frequency-division multiplexing (OFDM), or discrete Fourier transform-spread-orthogonal frequency-division multiplexing (DFT-S-OFDM). In one or more examples, when the wakeup signal includes ASK, an on stage (e.g., a one (1) bit) of the wakeup signal may be indicated by a first power (e.g., a high power) using on-off keying (OOK), a sinewave, a constant envelope, or OFDM. In some examples, an off stage (e.g., a zero (0) bit) of the wakeup signal may be indicated by no power within the wakeup signal or a second power (e.g., a low power) within the wakeup signal, where the first power is greater than the second power. In one or more examples, the first device may store (e.g., within memory) the energy from the energizing signal.

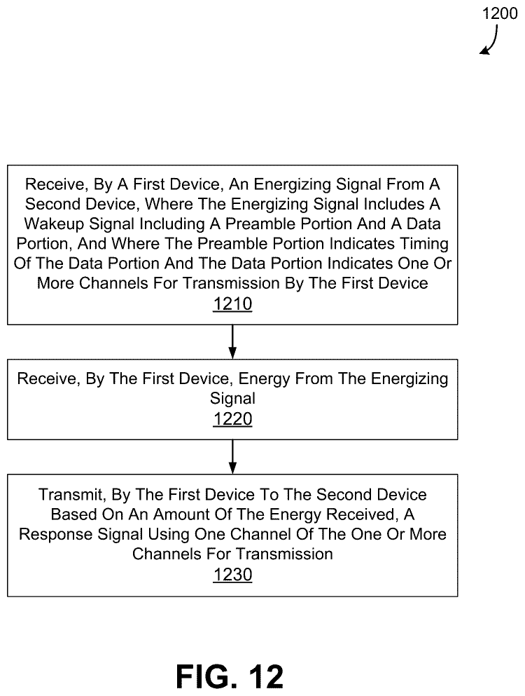

FIG. 12 is a flow chart illustrating an example of a process 1200 for wireless communications. The process 1200 can be performed by a first device (e.g., device 500 of FIG. 5, passive RFID tag 615 of FIG. 6, device 700 of FIG. 7, device 815 of FIG. 8, and/or a computing device or computing system 1100 of FIG. 11) or by a component or system (e.g., a chipset, one or more processors such as one or more central processing units (CPUs), digital signal processors (DSPs), graphics processing units (GPUs), any combination thereof, and/or other type of processor(s), or other component or system) of the first device. The operations of the process 1200 may be implemented as software components that are executed and run on one or more processors (e.g., processor 1310 of FIG. 31 or other processor(s), such as center controller 561 of FIG. 5). Further, the transmission and reception of signals by the first device in the process 1200 may be enabled, for example, by one or more antennas and/or one or more transceivers such as one or more wireless transceiver(s) (e.g., the transmit module 750 of FIG. 7, the receive antenna 710 of FIG. 7, the transmit antenna 755 of FIG. 7, etc.).

At block 1210, the first device (or component thereof, such as at least one transceiver) can receive an energizing signal from a second device. For instance, the first device may be an electronic tag (e.g., tag 815 of FIG. 8) and the second device may be a tag reader (e.g., reader 810 of FIG. 8). The energizing signal includes a wakeup signal including a preamble portion and a data portion (e.g., wakeup signal 900 of FIG. 9 including the preamble portion 910 and the data portion 920). The preamble portion indicates timing of the data portion, and the data portion indicates one or more channels for transmission by the first device. In some cases, the energizing signal further includes a synchronization signal with a synchronization waveform. In some aspects, to receive the energizing signal, the first device (or component thereof) can receive the wakeup signal at a first time and can receive the synchronization signal at a second time. In some cases, the first device (or component thereof) can receive the synchronization signal at the second time based on a time delay (e.g., the time delay 1040 illustrated in FIG. 10) between transmission of the wakeup signal and the synchronization signal. In some examples, the first device (or component thereof) can search for a sequence of the wakeup signal. In some cases, in response to detection of the sequence of the wakeup signal, the first device (or component thereof) can tune a frequency for the first device based on the synchronization waveform of the synchronization signal.

In some examples, the data portion includes channel selection information indicating the one or more channels for transmission by the first device. For instance, the channel selection information can include a first bit corresponding to a fixed channel or a second bit corresponding to multiple channels. In one illustrative example, upon receiving the channel selection information, the first device can select a single channel if the bit is the first bit (e.g., a zero (0) bit) or can select one of the multiple channels (or more than one of the multiple channels) if the bit is the second bit (e.g., a one (1) bit).

In some aspects, the wakeup signal may include amplitude shift keying, phase shift keying, frequency shift keying, orthogonal frequency-division multiplexing, or discrete Fourier transform-spread-orthogonal frequency-division multiplexing. For instance, if (or based on) the wakeup signal includes amplitude shift keying, an on stage of the wakeup signal is indicated by a first power using one of on-off keying, a sinewave, a constant envelope, orthogonal frequency-division multiplexing, or discrete Fourier transform-spread-orthogonal frequency-division multiplexing. In some cases, an off stage of the wakeup signal is indicated by no power within the wakeup signal or a second power within the wakeup signal, where the first power is greater than the second power.

At block 1220, the first device (or component thereof) can receive energy from the energizing signal. For instance, the first device (or component thereof) can store the energy from the energizing signal (e.g., in an energy storage element, such as the capacitor 725 of FIG. 7).

At block 1230, the first device (or component thereof, such as at least one transceiver) can transmit (or output for transmission) to the second device based on an amount of the energy received, a response signal using one channel of the one or more channels for transmission.

In some cases, the computing device of process 1200 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1200 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1200 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1200 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

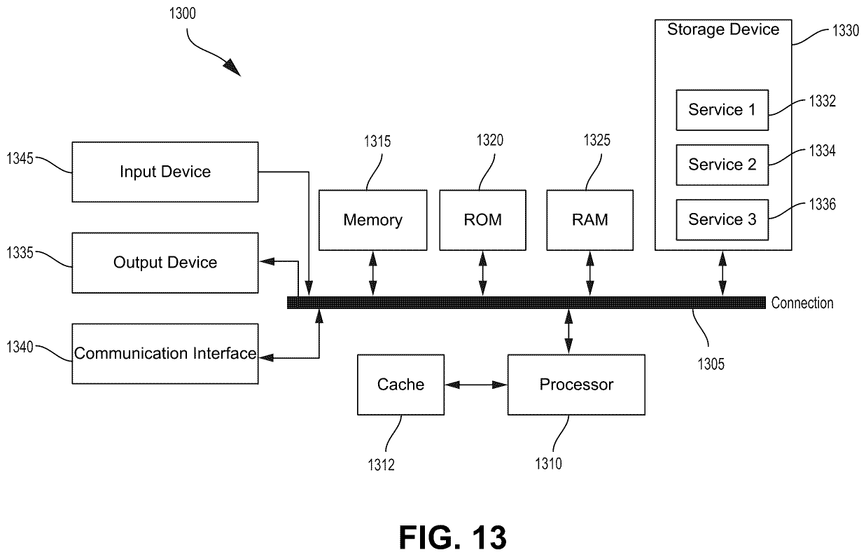

FIG. 13 is a block diagram illustrating an example of a computing system 1300, which may be employed for electronic tag systems downlink (DL) wakeup data. In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300.

Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LiDAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. A first device for wireless communications, the first device comprising: at least one memory; and at least one processor coupled to the at least one memory and configured to: receive an energizing signal from a second device, the energizing signal comprising a wakeup signal including a preamble portion and a data portion, wherein the preamble portion indicates timing of the data portion and the data portion indicates one or more channels for transmission by the first device; receive energy from the energizing signal; and output, for transmission to the second device based on an amount of the energy received, a response signal using one channel of the one or more channels for transmission.

Aspect 2. The first device of Aspect 1, wherein the energizing signal further comprises a synchronization signal including a synchronization waveform.

Aspect 3. The first device of Aspect 2, wherein, to receive the energizing signal, the at least one processor is configured to: receive the wakeup signal at a first time; and receive the synchronization signal at a second time.

Aspect 4. The first device of Aspect 3, wherein the at least one processor is configured to receive the synchronization signal at the second time based on a time delay between transmission of the wakeup signal and the synchronization signal.

Aspect 5. The first device of any of Aspects 2 to 4, wherein the at least one processor is configured to search for a sequence of the wakeup signal.

Aspect 6. The first device of Aspect 5, wherein the at least one processor is configured to tune, in response to detection of the sequence of the wakeup signal, a frequency for the first device based on the synchronization waveform of the synchronization signal.

Aspect 7. The first device of any of Aspects 1 to 6, wherein the data portion comprises channel selection information indicating the one or more channels for transmission by the first device.

Aspect 8. The first device of Aspect 7, wherein the channel selection information comprises one of a first bit corresponding to a fixed channel or a second bit corresponding to multiple channels.

Aspect 9. The first device of any of Aspects 1 to 8, wherein the wakeup signal comprises one of amplitude shift keying, phase shift keying, frequency shift keying, orthogonal frequency-division multiplexing, or discrete Fourier transform-spread-orthogonal frequency-division multiplexing.

Aspect 10. The first device of Aspect 9, wherein, based on the wakeup signal comprising amplitude shift keying, an on stage of the wakeup signal is indicated by a first power using one of on-off keying, a sinewave, a constant envelope, orthogonal frequency-division multiplexing, or discrete Fourier transform-spread-orthogonal frequency-division multiplexing.

Aspect 11. The first device of Aspect 10, wherein an off stage of the wakeup signal is indicated by one of no power within the wakeup signal or a second power within the wakeup signal, and wherein the first power is greater than the second power.

Aspect 12. The first device of any of Aspects 1 to 11, wherein the at least one processor is configured to store the energy from the energizing signal.

Aspect 13. The first device of any of Aspects 1 to 12, wherein the first device is an electronic tag.

Aspect 14. The first device of any of Aspects 1 to 13, wherein the second device is a tag reader.

Aspect 15. The first device of any of Aspects 1 to 14, further comprising at least one transceiver configured to: receive the energizing signal; and transmit the response signal.

Aspect 16. A method of wireless communications, the method comprising: receiving, by a first device, an energizing signal from a second device, the energizing signal comprising a wakeup signal including a preamble portion and a data portion, wherein the preamble portion indicates timing of the data portion and the data portion indicates one or more channels for transmission by the first device; receiving, by the first device, energy from the energizing signal; and transmitting, by the first device to the second device based on an amount of the energy received, a response signal using one channel of the one or more channels for transmission.

Aspect 17. The method of Aspect 16, wherein the energizing signal further comprises a synchronization signal including a synchronization waveform.

Aspect 18. The method of Aspect 17, wherein receiving, by the first device, the energizing signal comprises: receiving the wakeup signal at a first time; and receiving the synchronization signal at a second time.

Aspect 19. The method of Aspect 18, wherein receiving the synchronization signal at the second time is based on a time delay between transmission of the wakeup signal and the synchronization signal.

Aspect 20. The method of any of Aspects 17 to 19, further comprising searching, by the first device, for a sequence of the wakeup signal.

Aspect 21. The method of Aspect 20, further comprising tuning, by the first device in response to detection of the sequence of the wakeup signal, a frequency for the first device based on the synchronization waveform of the synchronization signal.

Aspect 22. The method of any of Aspects 16 to 21, wherein the data portion comprises channel selection information indicating the one or more channels for transmission by the first device.

Aspect 23. The method of Aspect 22, wherein the channel selection information comprises one of a first bit corresponding to a fixed channel or a second bit corresponding to multiple channels.

Aspect 24. The method of any of Aspects 16 to 23, wherein the wakeup signal comprises one of amplitude shift keying, phase shift keying, frequency shift keying, orthogonal frequency-division multiplexing, or discrete Fourier transform-spread-orthogonal frequency-division multiplexing.

Aspect 25. The method of Aspect 24, wherein, based on the wakeup signal comprising amplitude shift keying, an on stage of the wakeup signal is indicated by a first power using one of on-off keying, a sinewave, a constant envelope, orthogonal frequency-division multiplexing, or discrete Fourier transform-spread-orthogonal frequency-division multiplexing.

Aspect 26. The method of Aspect 25, wherein an off stage of the wakeup signal is indicated by one of no power within the wakeup signal or a second power within the wakeup signal, and wherein the first power is greater than the second power.

Aspect 27. The method of any of Aspects 16 to 26, further comprising storing, by the first device, the energy from the energizing signal.

Aspect 28. The method of any of Aspects 16 to 27, wherein the first device is an electronic tag.

Aspect 29. The method of any of Aspects 16 to 28, wherein the second device is a tag reader.

Aspect 30. A non-transitory computer-readable medium having stored thereon instructions that, when executed by at least one processor, cause the at least one processor to perform operations according to any of Aspects 16 to 29.

Aspect 31. An apparatus for wireless communications, the apparatus including one or more means for performing operations according to any of Aspects 16 to 29.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

1. A first device for wireless communications, the first device comprising:
at least one memory; and
at least one processor coupled to the at least one memory and configured to:
receive an energizing signal from a second device, the energizing signal comprising a wakeup signal including a preamble portion and a data portion and a synchronization signal including a synchronization waveform, wherein the preamble portion indicates timing of the data portion and the data portion indicates one or more channels for transmission by the first device;
receive the wakeup signal at a first time;
receive the synchronization signal at a second time based on a time delay between transmission of the wakeup signal and the synchronization signal;
receive energy from the energizing signal; and
output, for transmission to the second device based on the received energy being a sufficient amount of energy for transmission, a response signal using one channel of the one or more channels for transmission.

2. (canceled)

3. (canceled)

4. (canceled)

5. The first device of claim 1, wherein the at least one processor is configured to search for a sequence of the wakeup signal.

6. The first device of claim 5, wherein the at least one processor is configured to tune, in response to detection of the sequence of the wakeup signal, a frequency for the first device based on the synchronization waveform of the synchronization signal.

7. The first device of claim 1, wherein the data portion comprises channel selection information indicating the one or more channels for transmission by the first device.

8. The first device of claim 7, wherein the channel selection information comprises one of a first bit corresponding to a fixed channel or a second bit corresponding to multiple channels.

9. The first device of claim 1, wherein the wakeup signal comprises one of amplitude shift keying, phase shift keying, frequency shift keying, orthogonal frequency-division multiplexing, or discrete Fourier transform-spread-orthogonal frequency-division multiplexing.

10. The first device of claim 9, wherein, based on the wakeup signal comprising amplitude shift keying, an on stage of the wakeup signal is indicated by a first power using one of on-off keying, a sinewave, a constant envelope, orthogonal frequency-division multiplexing, or discrete Fourier transform-spread-orthogonal frequency-division multiplexing.

11. The first device of claim 10, wherein an off stage of the wakeup signal is indicated by one of no power within the wakeup signal or a second power within the wakeup signal, and wherein the first power is greater than the second power.

12. The first device of claim 1, wherein the at least one processor is configured to store the energy from the energizing signal.

13. The first device of claim 1, wherein the first device is an electronic tag.

14. The first device of claim 1, wherein the second device is a tag reader.

15. The first device of claim 1, further comprising at least one transceiver configured to:
receive the energizing signal; and
transmit the response signal.

16. A method of wireless communications, the method comprising:
receiving, by a first device, an energizing signal from a second device, the energizing signal comprising a wakeup signal including a preamble portion and a data portion and a synchronization signal including a synchronization waveform, wherein the preamble portion indicates timing of the data portion and the data portion indicates one or more channels for transmission by the first device;
receiving the wakeup signal at a first time;
receiving the synchronization signal at a second time based on a time delay between transmission of the wakeup signal and the synchronization signal;
receiving, by the first device, energy from the energizing signal; and
transmitting, by the first device to the second device based on the received energy being a sufficient amount of energy for transmission, a response signal using one channel of the one or more channels for transmission.

17. (canceled)

18. (canceled)

19. (canceled)

20. The method of claim 16, further comprising:
searching, by the first device, for a sequence of the wakeup signal; and
tuning, by the first device in response to detection of the sequence of the wakeup signal, a frequency for the first device based on the synchronization waveform of the synchronization signal.
